(19) United States
(12) Patent Application Publication
(10) Pub. No.: US 2008/0260157 A1
(43) Pub. Date: Oct. 23, 2008

(54) Recording Apparatus and Recording Medium

(75) Inventor: Kenichiro Yamauchi, Kyoto (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 11/663,971

(22) PCT Filed: Jul. 28, 2006
(86) PCT No.: PCT/JP2006/315022

§ 371 Date: Mar. 28, 2007

(30) Foreign Application Priority Data
Jul. 29, 2005 (JP) 2005-221814

(51) Int. Cl. H04L 9/06

(52) U.S. Cl. 380/277

(57) ABSTRACT

A recording apparatus includes an encryption/decryption section for encrypting first and second contents obtained from the same content, using first and second keys, respectively, and outputting the results as first and second encrypted contents, respectively, and a recording medium. The encryption/decryption section encrypts the first and second keys using the second and first keys, respectively, and outputs the results as first and second encrypted keys, respectively, to the recording medium. The recording medium records the first and second encrypted contents and the first and second encrypted keys.

### TECHNICAL FIELD

The present invention relates to recording media, such as HDDs (Hard Disk Drives), DVDs (Digital Versatile Discs) and the like, and more particularly, to a recording medium in which an encrypted content, such as video, audio or the like, is recorded, and a recording apparatus for the same.

### BACKGROUND ART

Apparatuses for recording contents, such as video, audio or the like, into recording media, such as HDDs, DVDs or the like, are becoming widespread. In particular, since HDDs have larger capacities than those of other recording media, apparatuses are increasingly becoming available in which an HDD is combined with an apparatus which employs another recording medium, such as an SD (Secure Digital) card, a DVD or the like. As an example of such apparatuses, AV contents are encoded using an encoding method, such as MPEG2 (moving picture experts group 2) or the like, and are recorded into an HDD, and are subsequently copied or moved from the HDD to a recording medium, such as a DVD or the like.

As used herein, the term “copy” indicates that a content for playback is moved from an HDD to a DVD or the like while the reproduced content is left in the HDD. The term “move” indicates that a content for playback is moved from an HDD to a DVD or the like while the content is not left in the HDD.

When a content is copied from an HDD to a DVD, the content can be reproduced by a DVD player. When a content is copied from a copied DVD to an HDD, and is further copied from the HDD to an SD card, the content can be reproduced in a mobile apparatus, such as a mobile telephone or the like, in addition to the DVD, resulting in a significant increase in convenience for users.

However, DVDs and SD cards for use in mobile apparatuses have different formats for recording contents. Video and audio contents are recorded on DVDs in the DVD Video Recording Format (hereinafter referred to as DVD-VR), and in SD cards using a compression technique, such as mainly the MPEG4 Simple Profile format or the like (hereinafter referred to as ASF (Advanced Systems Format)).

There are differences in the screen size and audio quality of contents between DVD-VR and ASF. In DVD-VR, since a typical television screen is assumed, data having a screen size of 720 (width)×480 (length) pixels is compressed in the case of video of NTSC (national television system committee). On the other hand, in the case of ASF, data having a smaller screen size (e.g., 240 (length)×160 (width) pixels, etc.) than that of DVD-VR may be compressed so that the data can be reproduced in a mobile apparatus.

Therefore, when an image stored in an SD card is converted into DVD-VR before being copied to a DVD, i.e., converted from ASF into DVD-VR, a content for a small screen is converted into a content for a large screen. Therefore, as compared to when the content is directly copied from an HDD to a DVD, the image quality of the content is significantly deteriorated.

To overcome this problem, when a content is initially recorded into an HDD, the content may be recorded both in the DVD-VR and ASF formats, utilizing the advantage that HDDs have capacities much larger than those of other recording media. In this case, the deterioration of the image quality due to copying can be avoided.

Further, in some cases, consideration needs to be given to the protection of the copyrights of contents. In particular, it is important to consider how copyright-protected contents are transferred between different apparatuses, and what kind of copyright protection is performed for contents recorded in recording media. An exemplary method of controlling the permission of copying of contents is disclosed in Patent Document 1 below.

Patent Document 1 describes that copy control information is represented by a flag indicating “Copy Free”, “Copy Once” or “No More Copy” and the flag is incorporated in a content in order to achieve copy control. Particularly, in recent years, as digital broadcasting is made more widespread, content providers more often transmit contents in the “Copy Once” state. This indicates that broadcast senders permit private duplication, but minimize attempts to decrypt the encryption of contents by reducing the number of times of duplication.

Here, as an exemplary system for recording digital contents into an HDD and duplicating the contents to an SD card or a DVD, a digital recorder is discussed. The digital recorder has an internal HDD, records digital contents transmitted through a digital tuner or the like into the HDD, and “copies” or “moves” the contents to an SD card or a DVD. The digital recorder can also “copy” or “move” contents of an SD card or a DVD to the internal HDD.

When digital contents are recorded, the digital recorder records the contents into the internal HDD in the two formats, i.e., DVD-VR and ASF, so that the contents can be “copied” or “moved” to a DVD or an SD card as described above.

Assuming that a digital content is a “Copy Once” content, when the content is present in the internal HDD of the digital recorder and is moved to a DVD or an SD card, a plurality of copies must not be present, because of “Copy Once”. In other words, after the content is “moved” to the SD card or the DVD, the content present in the HDD must be erased. In this case, for example, when a content present in the internal HDD of the digital recorder is “moved” to the SD card, the DVD-VR data as well as the ASF file must be erased from the internal HDD. As used herein, the term “erase” refers to an operation which causes digital data in the internal HDD not to be able to be decoded even if the HDD is analyzed.
Patent Document 1: Japanese Patent Unexamined Publication No. 2004-7494

### DISCLOSURE OF THE INVENTION

### Problems to be Solved by the Invention

However, after a content present in the internal HDD of the digital recorder is “moved” to the SD card, if the content contained in the SD card is “moved” back to the HDD, only the content in ASF for SD cards is present in the internal HDD of the digital recorder after the “move”. In this case, when the content is subsequently “moved” from the HDD to a DVD, the ASF content must be converted into DVD-VR, so that the image quality is significantly reduced during conversion of ASF into DVD-VR. This is because, when a “Copy Once” content is moved to an SD card, a content other than the file in the ASF format for SD cards is also erased from the HDD.

An object of the present invention is to provide a recording medium in which a content is recorded in a manner which does not reduce the quality even when the content is moved between a plurality of recording media, and a recording apparatus for the same.

### Solution to the Problems

A recording apparatus of the present invention comprises an encryption/decryption section for encrypting first and second contents obtained from the same content, using first and second keys, respectively, and outputting the results as first and second encrypted contents, respectively, and a recording medium. The encryption/decryption section encrypts the first and second keys using the second and first keys, respectively, and outputs the results as first and second encrypted keys, respectively, to the recording medium. The recording medium records the first and second encrypted contents and the first and second encrypted keys.

Thereby, when the second encrypted content and the second key for decrypting the encryption are moved to another recording medium, the first encrypted key can be no longer decrypted. In other words, the first content cannot be decrypted. Therefore, the requirement for “Copy Once” can be satisfied without erasing the first content.

A recording medium of the present invention is also provided, in which first and second encrypted contents obtained by encrypting first and second contents obtained from the same content, using first and second keys, respectively, and first and second encrypted keys obtained by encrypting the first and second keys, respectively, are recorded. The first encrypted key is obtained by encrypting the first key using a part of the second key.

### Effect of the Invention

According to the present invention, when a content given a condition for “Copy Once” is moved between a plurality of recording media, format conversion is not required for each move, thereby making it possible to avoid a deterioration in the image quality of the content.

### BRIEF DESCRIPTION OF THE DRAWINGS

FIG. 1 is a block diagram illustrating a recording apparatus according to an embodiment of the present invention.

FIG. 2 is a diagram for describing a process flow in the recording apparatus of FIG. 1.

FIG. 3 is a diagram for describing encryption of a key K1.

FIG. 4 is a diagram for describing decryption of an encrypted key KE1.

FIG. 5 is a diagram for describing a variation of the process flow of the recording apparatus of FIG. 1.

FIG. 6 is a diagram for describing an example of temporal variation of keys used for encryption.

FIG. 7 is a diagram for describing encryption of the key K1 when a key K2 is varied over time.

FIG. 8 is a diagram for describing an operation of reflecting copy control information CCI on an encryption key for a content.

FIG. 9 is a diagram for describing encryption of the key K1 where the copy control information CCI is reflected.

FIG. 10 is a diagram for describing encryption of a key region R3 which is not encrypted in FIG. 3.

### DESCRIPTION OF THE REFERENCE CHARACTERS

22 encryption/decryption section

24 HDD (recording medium)

42 DVD (recording medium)

44 SD card (recording medium)

100 recording apparatus

K1 first key

K2 second key

KE1 first encrypted key

KE2 second encrypted key

### BEST MODE FOR CARRYING OUT THE INVENTION

Hereinafter, embodiments of the present invention will be described with reference to the accompanying drawings.

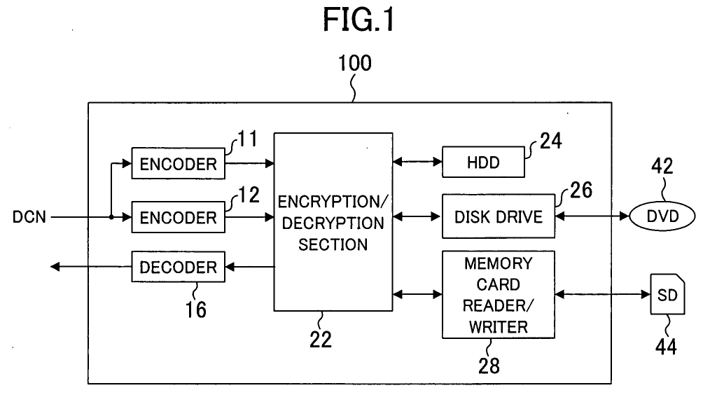

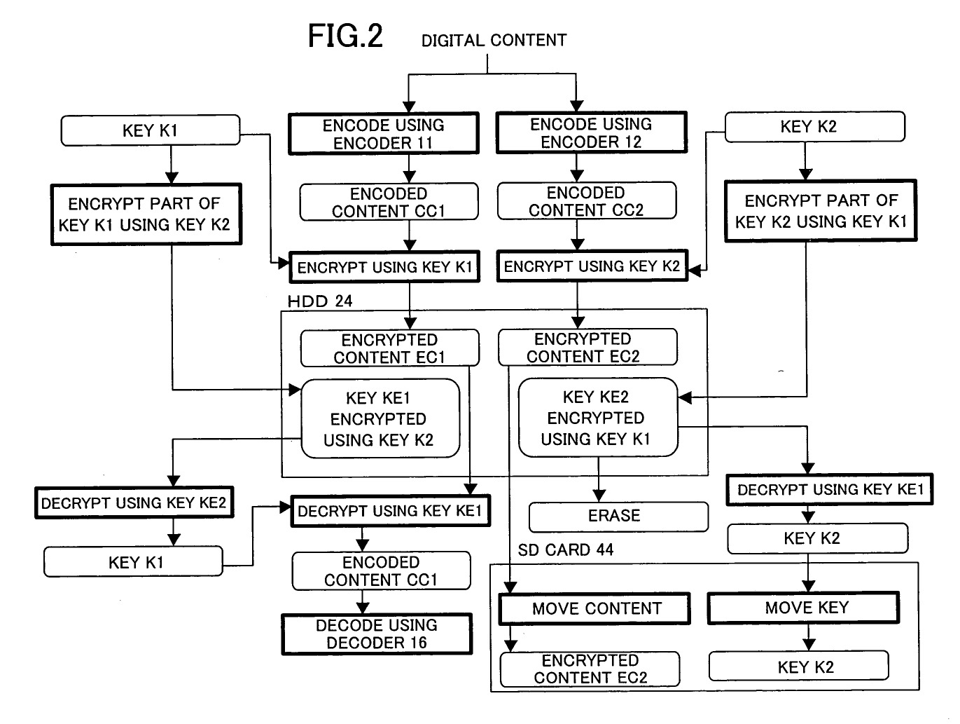

FIG. 1 is a block diagram illustrating a recording apparatus according to an embodiment of the present invention. The recording apparatus 100 of FIG. 1 comprises encoders 11 and 12, a decoder 16, an encryption/decryption section 22, an HDD 24 as a recording medium, a disk drive 26, and a memory card reader/writer 28. FIG. 2 is a diagram for describing a process flow in the recording apparatus of FIG. 1. In FIG. 2, processes surrounded by thick lines are performed by the recording apparatus of FIG. 1. As used herein, the recording medium refers to a disc, such as an HDD, a DVD or the like, or a semiconductor memory, such as an SD card or the like. Also, contents are data including video or audio or the like.

The recording apparatus of FIG. 1 will be described with reference to FIG. 2. The encoders 11 and 12 receive a digital content DCN. The encoder 11 encodes the digital content DCN using the DVD-VR format so that the content can be “copied” or “moved” to a DVD, and outputs the resultant content CC1 to the encryption/decryption section 22. The encoder 12 encodes the digital content DCN using the ASF format so that the content can be “copied” or “moved” to an SD card, and outputs the resultant encoded content CC2 to the encryption/decryption section 22.

The encryption/decryption section 22 subjects the encoded contents CC1 and CC2 to an encryption process so as to protect the copyright. Although an encryption method used in recording into the HDD is not particularly limited, different keys are used as keys for encryption of the contents. The encryption/decryption section 22 encrypts the encoded content CC1 using a first key K1, and outputs and records the resultant encrypted content EC1 to the HDD 24. Similarly, the encryption/decryption section 22 encrypts the encoded content CC2 using a second key K2, and outputs and records the resultant encrypted content EC2 to the HDD 24.

When the encoded content CC1 is reproduced from the HDD 24, the encrypted content EC1 needs to be decrypted using the key K1. To this end, the key K1 needs to be recorded in the HDD. Therefore, the encryption/decryption section 22 encrypts the key K1 using the whole or a part of the key K2, and outputs and records the resultant first encrypted key KE1 to the HDD 24. Similarly, the encryption/decryption section 22 encrypts the key K2 using the whole or a part of the key K1, and outputs and records the resultant second encrypted key KE2 to the HDD 24.

An encryption method used in DVD-VR and ASF which is used for recording into SD cards, is called CPRM (Content Protect for Recordable Media). In CPRM, a device key and an MKB (Media Key Block) are used for encryption of contents. The device key is a key which is given to an apparatus manufacturer from a licensing company, and is uniquely assigned to each apparatus. Also, a media ID and an MKB are recorded in a recording DVD or an SD card. As the media ID, a different ID is assigned to each disc or card.

The encryption/decryption section 22 initially uses the device key and the MKB to generate an encrypted media key, and encrypts the encrypted media key, a title key, and copy control information CCI in combination to generate an encrypted title key. The title key is a key which is actually used to encrypt a content, and corresponds to the key K1 or K2 described above. The copy control information CCI is information about duplication in which not only information indicating that duplication is permitted or not, but also information indicating how many times duplication can be permitted if duplication is permitted, are recorded. The above-described “Copy Free”, “Copy Once” and “No More Copy” are part of the copy control information CCI. The encrypted title key is a key which is recorded along with a content into a DVD or an SD card. Since the key itself is encrypted using the media ID or the apparatus information, the encryption cannot be decrypted even when only contents are copied.

In this embodiment, as the key K1 and the key K2, keys having the same length of 56 bits as that of a key used for CPRM are used. In the encryption method for the encoded content CC1 and the encoded content CC2, C2 encryption, DES (Data Encryption Standard) encryption or the like which uses a 56-bit key, can be used. In this embodiment, C2 encryption which is the same as that used for CPRM is used for encryption of the encoded contents CC1 and CC2.

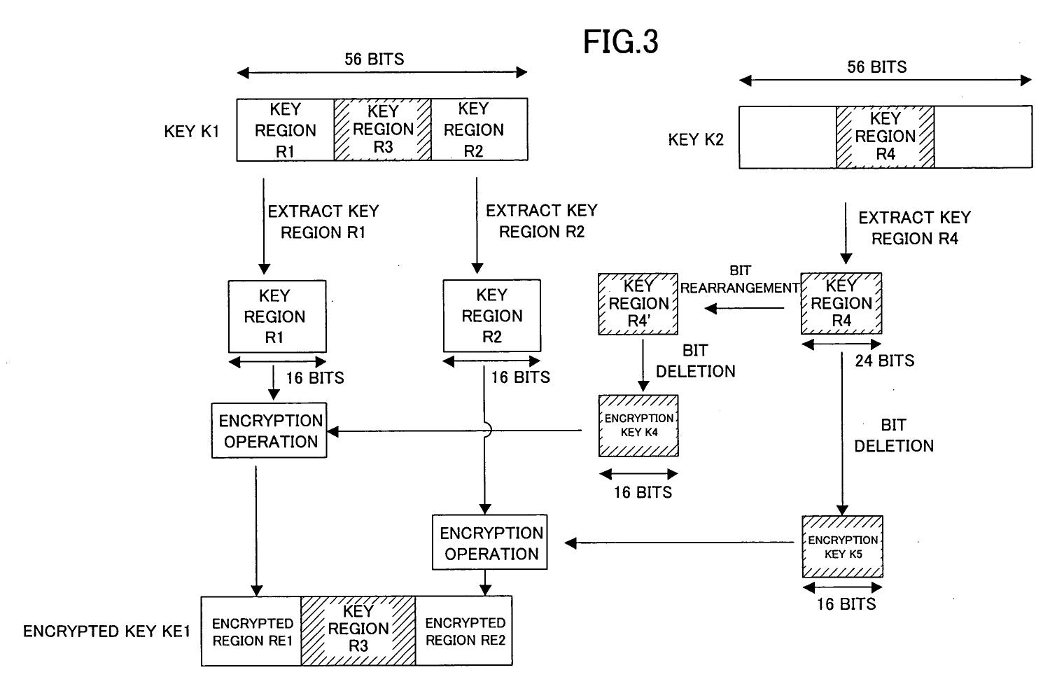

FIG. 3 is a diagram for describing encryption of the key K1. As illustrated in FIG. 3, the key K1 is divided into three key regions R1, R2 and R3. The key region R1 contains the upper 16 bits of the 56-bit key K1, the key region R3 contains 24 bits following the key region R1, and the key region R2 contains 16 bits following the key region R3. The key K2 is similarly divided into three key regions (R4, etc.). The key region R4 contains middle 24 bits of the 56-bit key K2.

The encryption/decryption section 22 rearranges the bits of the key region R4 in a predetermined manner, and deletes predetermined bits from the resultant key region R4′, to generate a 16-bit encryption key K4. The encryption/decryption section 22 also only deletes predetermined bits from the key region R4 to generate a 16-bit encryption key K5.

The encryption/decryption section 22 encrypts the key region R1 using the encryption key K4 to generate an encrypted region RE1 having a length of 16 bits, and encrypts the key region R2 using the encryption key K5 to generate an encrypted region RE2 having a length of 16 bits. By arranging the encrypted region RE1, the key region R3, and the encrypted region RE2 in sequence, an encrypted key KE1 having a length of 56 bits can be obtained.

The key K2 is also encrypted in a manner similar to that for the key K1. Specifically, the encryption/decryption section 22 rearranges the key region R3 of the key K1 in a predetermined manner and deletes predetermined bits, and uses the resultant encryption key to encrypt the upper 16 bits of the key K2, and further, deletes predetermined bits from the key region R3 of the key K1, and uses the resultant encryption key to encrypt the lower 16 bits of the key K2. By arranging the encrypted upper 16 bits, the key region R4, and the encrypted lower 16 bits in sequence, an encrypted key KE2 having a length of 56 bits can be obtained.

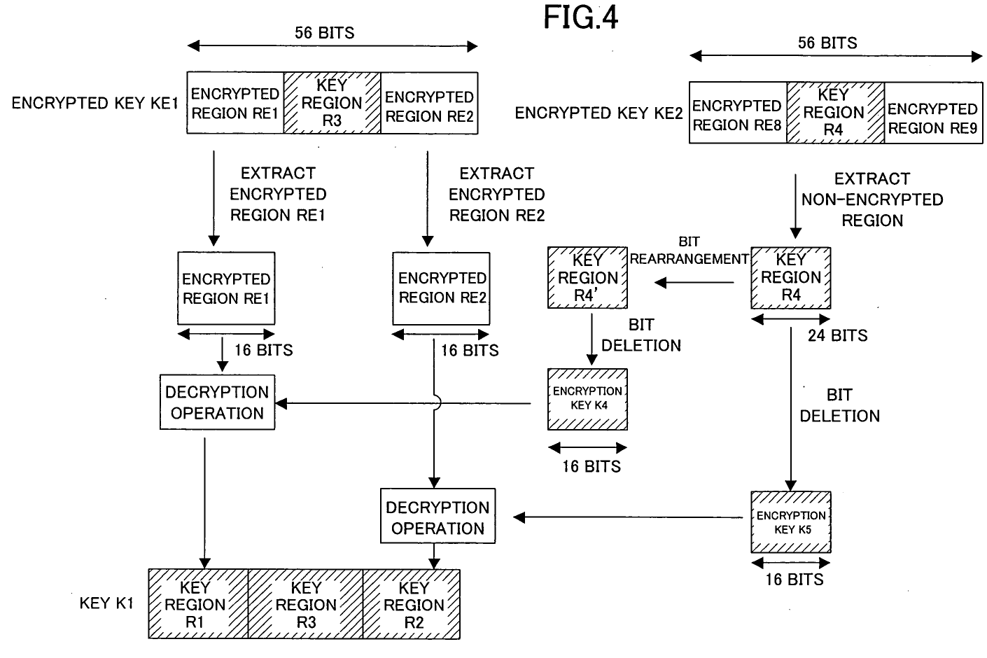

FIG. 4 is a diagram for describing decryption of the encrypted key KE1. When the encoded content CC1 is reproduced, the encryption/decryption section 22 decrypts the encrypted key KE1 using a part of the encrypted key KE2, and uses the resultant key K1 to decrypt the encryption of the encrypted content EC1. The decoder 16 decodes and outputs the encoded content CC1 which has been decrypted by the encryption/decryption section 22.

As illustrated in FIG. 4, the encrypted key KE1 has the 16-bit encrypted region RE1, the 24-bit key region R3, and the 16-bit encrypted region RE2 in descending order. Also, the encrypted key KE2 similarly has three regions, i.e., an encrypted region RE8, the key region R4, and an encrypted region RE9. Of those regions, the key regions R3 and R4 are not encrypted.

The encryption/decryption section 22 generates the encryption key K4 and the encryption key K5 from the key region R4 in a manner similar to that of FIG. 3, and further, uses the encryption key K4 to decrypt the encrypted region RE1 to restore the key region R1, and uses the encryption key K5 to decrypt the encrypted region RE2 to restore the key region R2. Thereafter, the encryption/decryption section 22 arranges the key regions R1, R3 and R2 in sequence to restore the key K1. Similarly, the encryption/decryption section 22 decrypts the encrypted key KE2 using a key generated from the key region R3 to restore the key K2.

Next, an operation of the recording apparatus of FIG. 1 when the encrypted content EC2 is “moved” to the SD card 44 will be described with reference to FIGS. 1 and 2. The encryption/decryption section 22 reads the encrypted content EC2 from the HDD 24, and outputs the encrypted content EC2 to the memory card reader/writer 28. The memory card reader/writer 28 writes the encrypted content EC2 into the SD card 44, and the encryption/decryption section 22 erases the encrypted content EC2 from the HDD 24. In other words, the encrypted content EC2 is “moved” from the HDD 24 to the SD card 44.

When the encrypted content EC2 in the HDD 24 has been encrypted by an encryption method other than C2 encryption, the encryption/decryption section 22 decrypts the encrypted content EC2 using the encryption method, and thereafter, encrypts the resultant content using C2 encryption again. The key KE2 encrypted using the key K1 is decrypted to the key K2 as described above, and thereafter, is handled as a title key for CPRM encryption of the SD card 44. The encryption/decryption section 22 decrypts the key KE2, generates an encrypted title key from the resultant key K2, records the encrypted title key into the SD card 44, and thereafter, erases the encrypted key KE2 left in the HDD 24.

Also, the encryption/decryption section 22 may directly “move” or “copy” the encrypted content EC2 from the HDD 24 to the SD card 44 without decryption into a plain text or encryption. In this case, the encryption/decryption section 22 decrypts the encrypted key KE2 to obtain the key K2, and encrypts the key K2 again, and thereafter, “moves” the resultant key from the HDD 24 to the SD card 44. When the key K2 is encrypted again, the encryption/decryption section 22 performs the encryption using a key which is different from that which has been used to obtain the encrypted key KE2 or using a method which is different from that which has been used to obtain the encrypted key KE2.

Although “move” from the HDD 24 to the SD card 44 has been here described, “move” from the HDD 24 to the DVD 42 is similarly performed. In this case, the disk drive 26 performs a write operation with respect to the DVD 42.

As described above, according to this embodiment, the key K1 which is required to decrypt the encrypted content EC1 which is left in the HDD 24 cannot be restored unless the key K2 which has been “moved” to the SD card 44 is available. In other words, if the key K2 is erased from the HDD 24, the encrypted contents EC1 and EC2 cannot be reproduced even by analyzing the HDD 24. Since the original key K2 has been erased from the HDD 24, it is possible to achieve a copyright protection function which is similar to conventional “move” in which all contents are removed.

Further, when a content is “moved” from the SD card 44 to the HDD 24, the key K2 can be restored in the HDD 24. Therefore, decryption of the encrypted key KE1 is enabled again, so that the encrypted content EC1 left in the HDD 24 can be reproduced and can be “moved” to the DVD 42. Since the encrypted content EC1 is encoded for DVDs, it is not necessary to convert an ASF-formatted content for SD cards into the DVD-VR format for DVDs, so that the image quality and sound quality of the content can be prevented from being deteriorated.

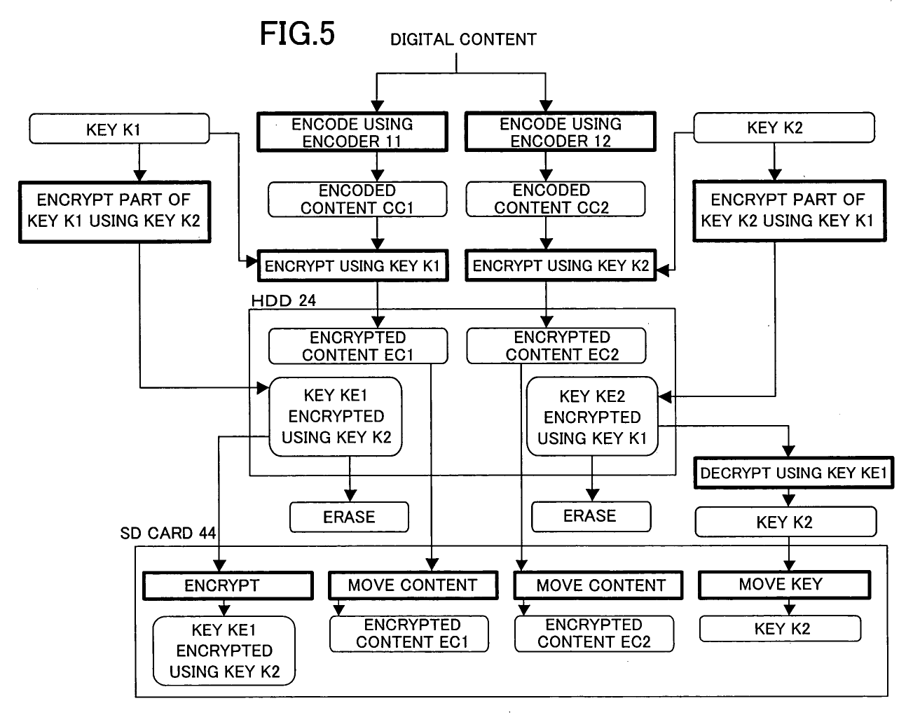

FIG. 5 is a diagram for describing a variation of the process flow of the recording apparatus of FIG. 1. In this variation, when the encrypted content EC2 is “moved” to an SD card, the encrypted content EC1 is also “moved” to the SD card 44 in addition to “move” of the encrypted content EC2 as in FIG. 2.

The encryption/decryption section 22 directly “moves” the encrypted content EC1 to the SD card 44, and erases the encrypted content EC1 which has been recorded in the HDD 24. Also, the encryption/decryption section 22 does not decrypt the key KE1 which has been encrypted using the key K2, and subjects the encrypted key KE1 to further encryption and records the resultant key into the SD card 44, and thereafter, erases the encrypted key KE1 left in the HDD 24.

The encrypted content EC1 encoded for DVDs cannot be reproduced on SD cards, but the encrypted content EC1 can be subsequently “moved” from the SD card 44 to the HDD 24 without loss of the encrypted content EC1. In other words, the image quality and the sound quality of the content can be prevented from being deteriorated, as in the case of FIG. 2.

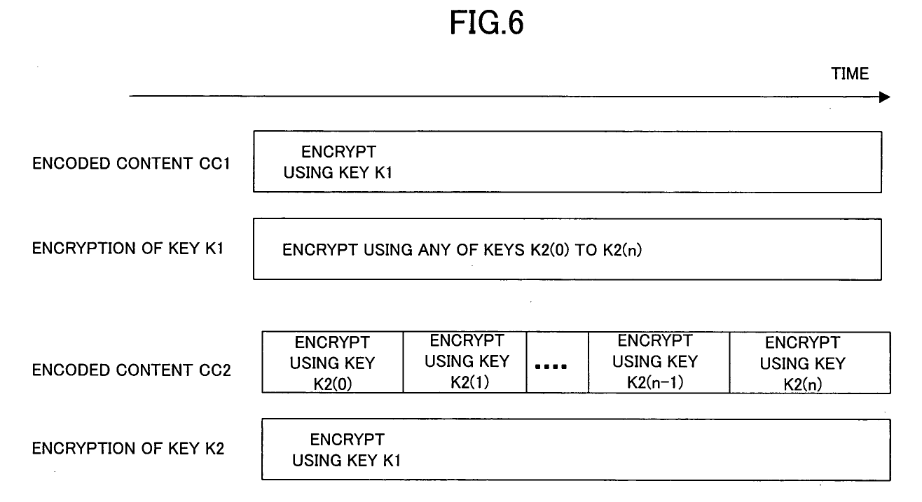

FIG. 6 is a diagram for describing an example of temporal variation of keys used for encryption. An encryption key used for encryption of a content may be varied over time during recording/reproduction of the content. For example, as illustrated in

FIG. 6, in the case of the encoded content CC1 for DVDs, there is mostly only one encryption key corresponding to one content. However, in the case of the encoded content CC2 for SD cards and the like, an encryption key is varied over time, e.g., keys K2(0), K2(1), . . . , and K2(n) (n is an integer of 0 or more). In this case, the encrypted content EC2 is encrypted using the keys K2(0) to K2(n) sequentially one by one. Also, 25 the key K1 needs to be encrypted using any of them.

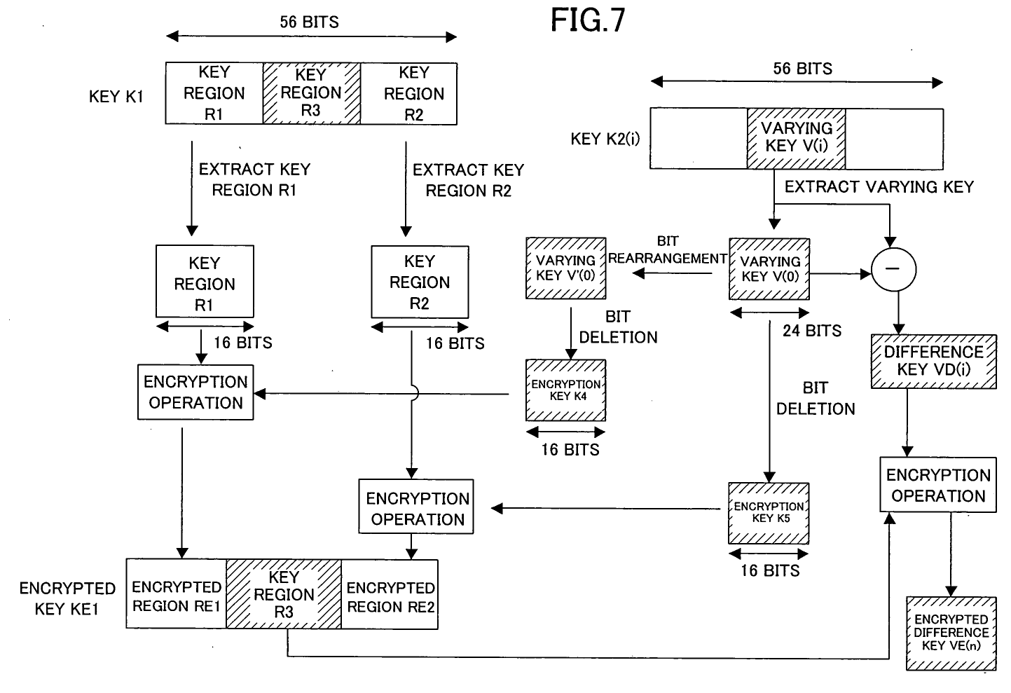

FIG. 7 is a diagram for describing encryption of the key K1 when the key K2 is varied over time. As illustrated in FIG. 7, a varying key V(i) is taken out from the temporally varying key K2(i) (i is an integer satisfying 0≦i≦n) and is used for encryption.

The encryption/decryption section 22 encrypts the key K1 using, for example, the varying key V(0) which is a leading key in time. In this case, however, the varying key V(0) may be lost by editing the encrypted content EC2, or the like. Therefore, the encryption/decryption section 22 obtains a difference between the varying key V(i) and the encryption key V(0) used for encryption as a difference key VD(i), which is stored into the HDD 24. In this case, even if the leading varying key V(0) is lost, the varying key V(0) can be generated from any varying key V(i) and the difference key VD(i) for restoration.

Although it has been here described that the varying key V(0) is used for encryption, other varying keys may be used. Alternatively, the key region R3 of the key K1 may be used to encrypt the difference key VD(i) to obtain an encrypted difference key VE(i), which is stored into the HDD 24. In this case, the concealment of a key can be improved.

The copy control information CCI which is information about duplication is very important for management of the entirety of a content. Although “move” of a content has been described in the embodiment above, a copy control can be performed so that copy is permitted only three times (“Copy Three Times”). An operation for this copy control is called check-in/check-out. For example, when a content is copied to an SD card, the number of times which copy is permitted is reduced from three to two, and when a content is moved from an SD card to an HDD, the number of times which copy is permitted is increased to three.

Information for such a copy control is included in the copy control information CCI. When a content is moved, checked out, or the like, the copy control information CCI needs to be updated to be reflected on the entire content.

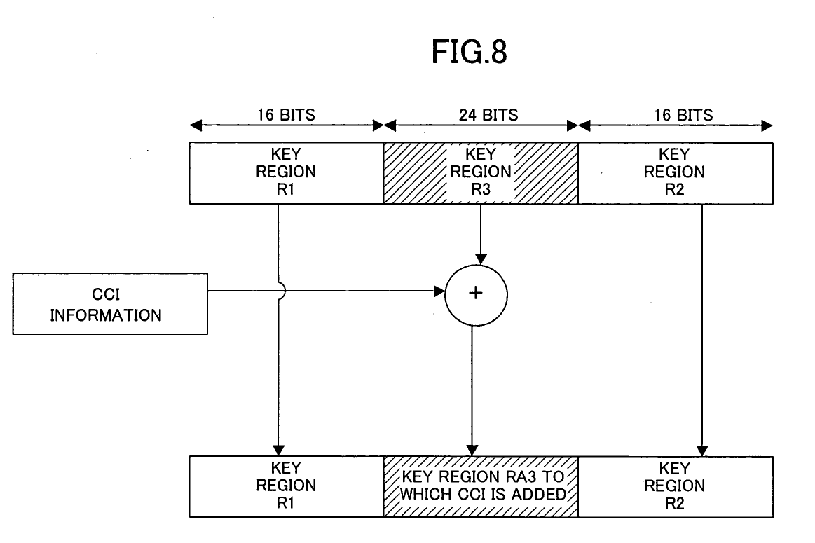

FIG. 8 is a diagram for describing an operation of reflecting the copy control information CCI on an encryption key for a content. In FIG. 8, in order to reflect the copy control information CCI on the entire content, the copy control information CCI is reflected on the encryption key for the content. Specifically, as illustrated in FIG. 8, the encryption/decryption section 22 adds the copy control information CCI to the 24 bits of the key region R3 which is used for encryption of another key to obtain a key region RA3. The encryption/decryption section 22 uses such an encryption key which is obtained by adding the copy control information CCI to the encryption key K1 to generate the encrypted content EC1.

Although it is here assumed that the copy control information CCI contains 24 bits, the copy control information CCI may contain any number of bits which are no more than 24 bits. Also, other operations, such as subtraction, exclusive OR, and the like, other than addition may be performed between the key region R3 and the copy control information CCI.

Thereby, encrypted contents having different copy control information CCI may have different encryption keys even if they are the same content. Even for the same content, a plurality of encrypted contents are generated. Therefore, particularly when check-in/check-out is performed, a stronger copyright protection function can be achieved.

It is considerably effective to directly incorporate the copy control information CCI into a key. In this case, however, when the copy control information CCI is updated, the key itself is changed, so that the entire content needs to be encrypted again, which requires a considerably large circuit. Therefore, the copy control information CCI may be added to a key which is used for encryption of an encryption key as described below.

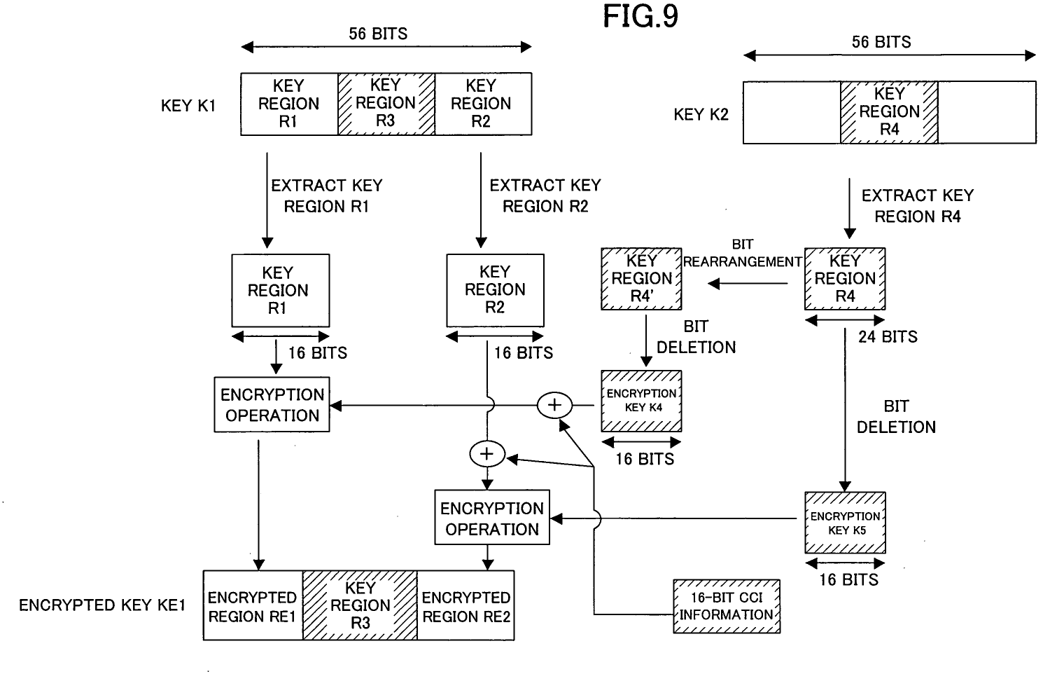

FIG. 9 is a diagram for describing encryption of the key K1 where the copy control information CCI is reflected. The encryption/decryption section 22 adds the copy control information CCI to the encryption key K4, and uses the result to encrypt the key region R1, and adds the copy control information CCI to the key region R2, and uses the encryption key K5 to encrypt the result. In other regards, FIG. 9 is similar to FIG. 3. As is different from the case of FIG. 8, it is here assumed that the copy control information CCI contains no more than 16 bits.

Thereby, even if the copy control information CCI is updated, only key information may be updated. Therefore, it is possible to reflect the copy control information CCI on encryption more quickly than in the case of FIG. 8.

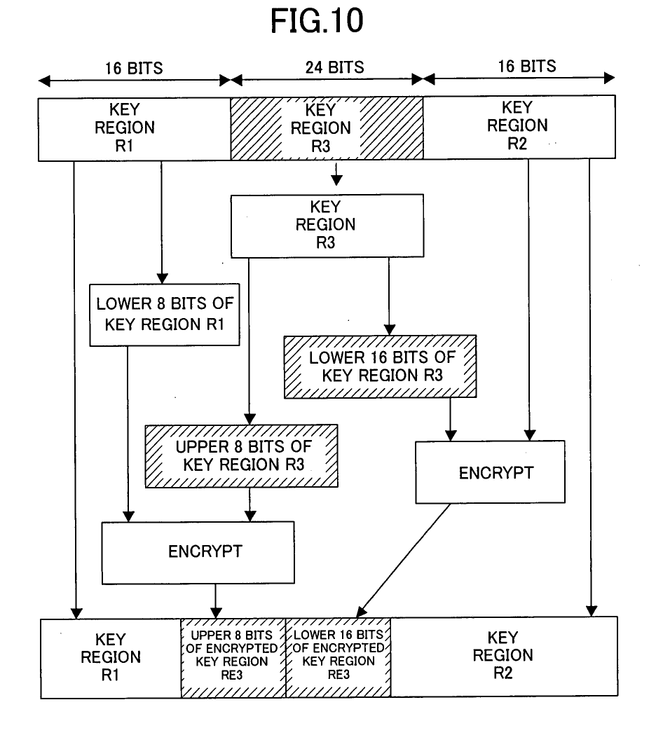

FIG. 10 is a diagram for describing encryption of the key region R3 which is not encrypted in FIG. 3. Since the key region R3 and the key region R4 of FIG. 3 and the like are not encrypted using any other encryption key, the encryption level of the keys themselves are lower than the other key regions. Therefore, the key region R3 of the key K1 is encrypted using the key region R1 and the key region R2 of the key K1 itself so as to improve the encryption level of the key region R3.

As illustrated in FIG. 10, the encryption/decryption section 22 divides the key region R3 into the lower 16 bits and the upper 8 bits. The encryption/decryption section 22 encrypts the lower 16 bits of the key region R3 using the 16 bits of the key region R2, and sets the result as the lower 16 bits of the encrypted key region RE3. Also, the encryption/decryption section 22 encrypts the upper 8 bits of the key region R3 using the lower 8 bits of the key region R1, and sets the result as the upper 8 bits of the encrypted key region RE3. Thereafter, using the encrypted key region RE3 instead of the key region R3, the encryption/decryption section 22 encrypts the key K2 in a manner similar to that of FIG. 3, and stores the result into the HDD 24.

Although an example has been here described, any bit of the key region R1 or the key region R2 may be used as an encryption key for encryption of the key region R3. Also, the result of encryption may be provided at any position in the encrypted key region RE3. Note that the position needs to be determined in accordance with a predetermined rule.

According to the embodiment above, a recording medium and a recording apparatus can be achieved which satisfy conditions, such as “Copy Once” and the like, and a deterioration in content due to “move” is avoided.

Although it is assumed in the above description that the HDD 24 stores the encrypted contents EC1 and EC2 and the encrypted keys KE1 and KE2, a recording DVD, a semiconductor memory or the like may store them.

Although the first key K1 is mainly focused in the above description about the processes, such as encryption and the like, processes similar to those described above may be performed with respect to the second key K2.

### INDUSTRIAL APPLICABILITY

As described above, the present invention, in which the quality of a content is not reduced even when the content is moved between recording media, is useful for a recording apparatus, a recording medium, and the like.

1. A recording apparatus comprises:
an encryption/decryption section for encrypting first and second contents obtained from the same content, using first and second keys, respectively, and outputting the results as first and second encrypted contents, respectively; and
a recording medium,
wherein the encryption/decryption section encrypts the first and second keys using the second and first keys, respectively, and outputs the results as first and second encrypted keys, respectively, to the recording medium, and
the recording medium records the first and second encrypted contents and the first and second encrypted keys.

2. The recording apparatus of claim 1, wherein
the encryption/decryption section moves or copies the second encrypted content recorded in the recording medium to another recording medium without decryption or encryption, and decrypts the second encrypted key to obtain the second key, encrypts the second key using a key different from the key used when obtaining the second encrypted key, or using a method different from a method used when obtaining the second encrypted key, and moves the result to the other recording medium.

3. The recording apparatus of claim 1, wherein
the encryption/decryption section moves the second encrypted content recorded in the recording medium to another recording medium, and decrypts the second encrypted key and moves the result to the other recording medium.

4. The recording apparatus of claim 3, wherein
the encryption/decryption section, when moving the second encrypted content to the other recording medium, moves the first encrypted content and the first encrypted key to the other recording medium without decryption.

5. The recording apparatus of claim 1, wherein
the first encrypted key has an encrypted region and a non-encrypted region.

6. The recording apparatus of claim 1, wherein
the encryption/decryption section encrypts the second content using a plurality of keys as the second key, sequentially one by one, to obtain the second encrypted content, and encrypts the first key using one of the plurality of keys as the second key to obtain the first encrypted key.

7. The recording apparatus of claim 6, wherein
the encryption/decryption section obtains a restoration key for generating the key which has been used to obtain the first encrypted key, from another key of the plurality of keys as the second key, and records the restoration key into the recording medium.

8. The recording apparatus of claim 7, wherein
the encryption/decryption section encrypts the restoration key using a part of the first key, and records the result into the recording medium.

9. The recording apparatus of claim 1, wherein
the encryption/decryption section performs an operation between the first key and copy control information to obtain the first encrypted key.

10. The recording apparatus of claim 1, wherein
the encryption/decryption section performs an operation between the part of the second key and copy control information, and performs encryption using the result to obtain the first encrypted key.

11. The recording apparatus of claim 1, wherein
the encryption/decryption section encrypts a partial region of the first key using a region of the first key other than the partial region to obtain the first encrypted key, and
the encryption/decryption section encrypts the second key using the partial region of the first key to obtain the second encrypted key.

12. A recording medium, wherein
first and second encrypted contents obtained by encrypting first and second contents obtained from the same content, using first and second keys, respectively, and first and second encrypted keys obtained by encrypting the first and second keys, respectively, are recorded, and
the first encrypted key is obtained by encrypting the first key using a part of the second key.

13. The recording medium of claim 12, wherein
the first encrypted key has an encrypted region and a non-encrypted region.

14. The recording medium of claim 12, wherein
the second encrypted content is obtained by encrypting the second content using a plurality of keys as the second key, sequentially one by one, and
the first encrypted key is obtained by encryption using one of the plurality of keys as the second key.

15. The recording medium of claim 14, wherein
a restoration key is further recorded for generating the key which has been used to obtain the first encrypted key, from another key of the plurality of keys as the second key.

16. The recording medium of claim 15, wherein
the restoration key is encrypted using a part of the first key.

17. The recording medium of claim 12, wherein
the first encrypted key is obtained by performing an operation between the first key and copy control information.

18. The recording medium of claim 12, wherein
the first encrypted key is obtained by encryption using a result from performing an operation between the part of the second key and copy control information.

19. The recording medium of claim 12, wherein
the first encrypted key is obtained by encrypting a partial region of the first key using a region of the first key other than the partial region, and
the second encrypted key is obtained by encrypting the second key using the partial region of the first key.
